(19) United States
(12) Patent Application Publication
(10) Pub. No.: US 2019/0310630 A1
(43) Pub. Date: Oct. 10, 2019

(54) CONTROL OF ROBOTIC VEHICLES BASED ON ATTENTION LEVEL OF OPERATOR

(71) Applicant: QUALCOMM Incorporated, San Diego, CA (US)

(72) Inventor: Michael TAVEIRA, Rancho Santa Fe, CA (US)

(21) Appl. No.: 15/949,311

(22) Filed: Apr. 10, 2018

(51) Int. Cl. G05D 1/00

(52) U.S. Cl. CPC G05D 1/0061; G05D 1/0011

(57) ABSTRACT

Embodiments include devices and methods for controlling a robotic vehicle, the method including detecting, by one or more processors, a distraction event while an operator is controlling the robotic vehicle and automatically controlling the robotic vehicle in response to detecting the distraction event.

### BACKGROUND

Robotic vehicles are increasingly used for a wide range of applications, including personal, commercial and government applications. Robotic vehicles are typically unmanned and may be operated by remote commands from an operator or in an autonomous mode where the robotic vehicle controls its own operations. In the case where the robotic vehicle is being controlled by remote commands from the operator, the operator is relied on to stay apprised of the conditions surrounding the robotic vehicle and to provide commands to operate the robotic vehicle in a safe and efficient manner.

There are various situations that may cause safety or privacy concerns, or other issues if a robotic vehicle is not controlled properly. For example, if the right commands are not received from the operator while the robotic vehicle is being controlled by the operator, the robotic vehicle may operate in a manner that may lead to collisions, flying into restricted areas, or other such situations that may cause concern.

In addition, robotic vehicles have limited resources, such as battery life. Because of these limited resources, it is important that while the resources are in use, the robotic vehicle is controlled in an efficient manner to make sure the resources are used in an optimal way. This can ensure that the robotic vehicle is able to complete the desired tasks, and provide an optimal result and/or user experience.

For at least these reasons, it is important that the operator of the robotic vehicle is alert and provides the right commands to the robotic vehicle during its flight. However, it is possible for an operator to become distracted during operation of the robotic vehicle. Therefore, it is desirable to address the possibility of distractions of the operator to avoid safety and privacy concerns, as well as any inefficient use of the robotic vehicle limited resources.

### SUMMARY

Various embodiments include methods that may be implemented on a processor of a robotic vehicle for controlling a robotic vehicle. In some embodiments, the method may include detecting, by one or more processors, a distraction event while an operator is controlling the robotic vehicle. In some embodiments, the method may further include automatically controlling the robotic vehicle in response to detecting the distraction event.

In some embodiments, automatically controlling the robotic vehicle may include controlling the robotic vehicle for the duration of the distraction event. In some embodiments, the robotic vehicle may be controlled by the user using a user equipment and detecting the distraction event while the operator is controlling the robotic vehicle may include detecting the distraction event on the mobile communication device while the operator is controlling the robotic vehicle with the mobile communication device.

In some embodiments, the distraction event may include receiving or placing a call on the mobile communication device. In some embodiments, the distraction event may include typing a message on the mobile communication device. In some embodiments, the distraction event may include switching from an application for controlling the robotic vehicle to a different application. In some embodiments, detecting the distraction event may include detecting a distraction activity and the distraction activity may include an activity different from the controlling of the robotic vehicle.

In some embodiments, detecting the distraction event may include detecting a distraction activity and the distraction activity may include at least one of the operator engaging in a phone call, the operator engaging in a text, chat, or email message, and the operator engaging with a software application other than an application for controlling the robotic vehicle. In some embodiments, the method may further include the distraction event has ended and returning control of the robotic vehicle to the operator in response to determining that the distraction event has ended. In some embodiments, the method may further include determining a time duration of the distraction event, determining whether the time duration of the distraction event exceeds a threshold and modifying the controlling of the robotic vehicle in response to the time duration exceeding the threshold.

In some embodiments, automatically controlling the robotic vehicle may include controlling the robotic vehicle to perform a first action and modifying the controlling of the robotic vehicle in response to the time duration exceeding the threshold may include controlling the robotic vehicle to perform a second action different from the first action.

In some embodiments, the method may further include detecting an additional distraction event during the controlling and modifying the controlling of the robotic vehicle based on the detecting of the additional distraction event.

In some embodiments, automatically controlling the robotic vehicle may include controlling the robotic vehicle to perform a first action and modifying the controlling of the robotic vehicle based on the detecting of the additional distraction event may include controlling the robotic vehicle to perform a second action different from the first action.

In some embodiments, automatically controlling the robotic vehicle may include controlling the robotic vehicle by one or more processors of the robotic vehicle without receiving further commands from the operator. In some embodiments, automatically controlling the robotic vehicle may include requesting control commands from a source other than the operator.

Various embodiments may further include a robotic vehicle having a processor configured with processor-executable instructions to perform operations of the methods summarized above. Various embodiments include a processing device for use in robotic vehicles and configured to perform operations of the methods summarized above. Various embodiments include a robotic vehicle having means for performing functions of the methods summarized above.

### BRIEF DESCRIPTION OF THE DRAWINGS

The accompanying drawings, which are incorporated herein and constitute part of this specification, illustrate example embodiments, and together with the general description given above and the detailed description given below, serve to explain the features of various embodiments.

FIG. 1 is a system block diagram of a robotic vehicle operating within a communication system according to various embodiments.

FIG. 2 is a component block diagram illustrating components of a robotic vehicle according to various embodiments.

FIG. 3 is a block diagram illustrating components of an example electronic device according to various embodiments.

FIG. 4 is a component block diagram illustrating an example processing device according to various embodiments.

FIG. 5 is a process flow diagram illustrating an example method of controlling operation of a robotic vehicle, according to various embodiments.

FIG. 6 is a process flow diagram illustrating an example method of switching control of operation of a robotic vehicle based on an attention level of an operator, according to various embodiments.

FIG. 7 is a process flow diagram illustrating an example method of controlling operation of a robotic vehicle, according to various embodiments.

FIG. 8 is a process flow diagram illustrating an example method of switching control of operation of a robotic vehicle based on detecting a distraction event, according to various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and embodiments are for illustrative purposes, and are not intended to limit the scope of the claims.

Various embodiments include methods that may be implemented on one or more processors for overriding control of a robotic vehicle based on the attention level of the operator. In various embodiments one or more processors may be configured to determine an attention level of the operator and determine if the attention level is below an acceptable level. In response to determining that the attention level of the operator is below an acceptable level, one or more processors may be configured to switch the control of the robotic vehicle to override operator control of the robotic vehicle, for example, by switching to autonomous control of the robotic vehicle. Accordingly, systems and methods may be implemented to address issues that may arise as a result of a distracted operator controlling the robotic vehicle.

As used herein, the terms “robotic vehicle” and “drone” refer to one of various types of vehicles including an onboard computing device configured to provide some autonomous or semi-autonomous capabilities. Examples of robotic vehicles include but are not limited to: aerial vehicles, such as an unmanned aerial vehicle (UAV); ground vehicles (e.g., an autonomous or semi-autonomous car, a vacuum robot, etc.); water-based vehicles (i.e., vehicles configured for operation on the surface of the water or under water); space-based vehicles (e.g., a spacecraft or space probe); and/or some combination thereof. In some embodiments, the robotic vehicle may be manned. In other embodiments, the robotic vehicle may be unmanned. In embodiments in which the robotic vehicle is autonomous, the robotic vehicle may include an onboard computing device configured to maneuver and/or navigate the robotic vehicle without remote operating instructions (i.e., autonomously), such as from a human operator (e.g., via a remote computing device). In embodiments in which the robotic vehicle is semi-autonomous, the robotic vehicle may include an onboard computing device configured to receive some information or instructions, such as from a human operator (e.g., via a remote computing device), and autonomously maneuver and/or navigate the robotic vehicle consistent with the received information or instructions. In some implementations, the robotic vehicle may be an aerial vehicle (unmanned or manned), which may be a rotorcraft or winged aircraft. For example, a rotorcraft (also referred to as a multirotor or multicopter) may include a plurality of propulsion units (e.g., rotors/propellers) that provide propulsion and/or lifting forces for the robotic vehicle. Specific non-limiting examples of rotorcraft include tricopters (three rotors), quadcopters (four rotors), hexacopters (six rotors), and octocopters (eight rotors). However, a rotorcraft may include any number of rotors. A robotic vehicle may include a variety of components and/or payloads that may perform a variety of functions. The term “components” when used with respect to a robotic vehicle includes robotic vehicle components and/or robotic vehicle payloads.

In various embodiments, systems and methods are provided for addressing issues that may arise due to a distracted operator when the robotic vehicle is receiving remote commands from an operator to control one or more operations of the robotic vehicle. A distractor operator is one that does not have a sufficient attention level with regard to control of the robotic vehicle. Various conditions may lead to the attention level of the operator falling below an acceptable level. In some embodiments, the operator may become distracted due to engagement in other actions. For example, a phone call, message or conversation (e.g., text, email or chat message or conversation), another event, engagement with applications (e.g., games), or other activities may distract the operator such that the attention level of the operator is not such that the operator may not be able to operate the robotic vehicle in a safe and efficient manner. Similarly, changes in the environment of the operator, such as weather changes, emergency situations, or other changes that may cause the operator's attention to be diverted such that the operator is not be able to sufficiently provide commands to the robotic vehicle. Therefore, it is beneficial to provide a mechanism for overriding control of the robotic vehicle based on the attention level of the operator.

In various embodiments, systems and methods are provided for detecting if the attention level of the operator and automatically controlling the robotic vehicle based on the attention level of the operator. In some examples, one or more processors may be configured to monitor the attention level of the operator. In some embodiments, the one or more processors may monitor the attention level of the operator if it is determined that the operator is controlling the robotic vehicle. For example, the attention level of the operator may be monitored once it is determined that the robotic vehicle is receiving one or more control commands from the operator. In other examples, monitoring of the attention level of the operator may occur in response to the robotic vehicle being in an operator mode where the robotic vehicle may be controlled by one or more commands from the operator.

In some examples, monitoring of the attention level of the operator may occur if response to a triggering event. The triggering event may include events that indicate a need to begin monitoring the attention level of the operator while the operator is providing control commands to the robotic vehicle. Such triggers may include, but are not limited to, certain behaviors of the operator, environmental conditions surrounding the operator, certain behaviors of the robotic vehicle, and/or conditions of the robotic vehicle.

In some embodiments, behaviors of the operator may trigger monitoring for the attention level of the operator and may include, but are not limited to, receiving indications of the operator engaging in certain activities (e.g., answering a phone call, engaging in conversation, engaging with one or more other devices or applications, etc.). In some example, the location and/or direction of the gaze and/or body of the operator may also provide a trigger to begin monitoring for the attention level of the operator (e.g., if the operator turns or looks away from the controller or the path of the robotic vehicle). In other examples, the physical characteristics of the operator may provide triggers for beginning to monitor for the attention level of the operator (e.g., whether the user is in any physical pain, whether the operator is suffering from any sudden health conditions or change in physical wellbeing, etc.).

In some examples, the environment of the operator may also provide triggers for monitoring the attention level of the operator. For example, certain changes in the surrounding of the operator may lead to an increase in the chance of the attention level of the operator falling below an acceptable level. Such changes may include, but are not limited to, change in weather, presence of other individuals, presence of sounds or events that may distract the operator, etc.

In various embodiments, certain behaviors of the robotic vehicle may provide a trigger for monitoring the attention level of the operator. Such behaviors may for example include behaviors that may indicate that the operator attention level is below an acceptable level (i.e., the control commands provided by the operator are causing the robotic vehicle to behave in a way that indicates the operator is distracted). Such behaviors may include behaviors that deviate from normal or expected behaviors. For example, such deviations may include the robotic vehicle moving in an erratic manner, diverting from its path, and/or behaving in an unexpected manner (e.g., based on historical information) based on control commands from the operator.

Conditions of the robotic vehicle may also provide a trigger for monitoring the attention level of the operator. For example, changes in the environmental conditions of the robotic vehicle may provide such trigger (e.g., changes that require attention from the operator). In other examples, changes to the condition of the robotic vehicle, such as battery level or malfunction of mechanical parts may trigger monitoring for the attention level of the operator.

The attention level of the operator may be monitored using one or more sensors or other equipment. For example, sensors or other equipment (e.g., cameras) of the controller of the robotic vehicle used by the operator may be used to monitor the attention level of the operator. Such sensors or other equipment may provide information such as the direction of the operator, the direction of the gaze of the operator, health condition of the operator, activities the operator is engaged in, surrounding information of the operator, etc.

In some embodiments, the operator may be associated with one or more user equipment (UE) and the UE may provide information that may be used for monitoring the attention level of the operator. In some examples, the UE may also act as the controller of the robotic vehicle while in other examples, the UE may be separate from and/or optionally in communication with the controller of the robotic vehicle. Examples of UEs include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, or any other similar functioning device. In some example, the UE may include sensors and other equipment (e.g., cameras) that may provide information regarding the operator (e.g., similar to those described above).

In some example embodiments, sensors or other equipment of the robotic vehicle may provide information regarding the behavior of the robotic vehicle or the environmental conditions of the robotic vehicle which may be used to monitor the attention level of the user. Alternatively, or in addition, other sensors, equipment, devices, or resources (e.g., servers, cameras, satellites) may be used to collect information regarding the operator or the environment regarding the operator, or the robotic vehicle, and may be used to monitor the attention level of the operator. In some examples, one or more remote sources may further provide information regarding the attention level of the operator. For example, one or more sources may provide information regarding historical behavior or conditions of the operator, robotic vehicle, and/or their surrounding environments.

In some examples, monitoring the attention level of the operator may include determining the attention level of the operator (e.g., periodically, or continuously). In various embodiments, one or more processors may determine an attention level of the operator based on various information, including, but not limited, the behavior of the operator, the environment of the operator, and/or the behavior and/or environment of the robotic vehicle.

In various embodiments, a UE associated with the operator may provide information regarding various activities of the operator with respect to the UE. For example, the UE may include one or more services or applications and may provide information regarding operator engagement with such services or applications that may be used to assess the attention level of the operator. For example, the information may include indications of the operator engaging in certain activities (e.g., answering a phone call, engaging in conversation, engaging with one or more other devices or applications, etc.). Such indications may include information from the controller or UE, such as information regarding the applications at the UE the user is engaged with (e.g., an incoming phone call), information picked up by one or more sensors or equipment such as cameras or microphones (e.g., conversations on the phone or nearby person, orientation of the UE or controller, gestures of the operator associate with certain activities, etc.).

In some examples, sensors or other equipment (e.g., cameras) of the controller of the robotic vehicle or other UE used by the operator may provide information such as the direction of the operator, the direction of the gaze of the operator, health condition of the operator, activities the operator is engaged in, surrounding information of the operator, etc. In such examples, the location and/or direction of the gaze or body of the operator may also provide information regarding the attention level of the operator (e.g., if the user turns or looks away from the controller or the path of the robotic vehicle). In other examples, the physical characteristics of the operator may provide an indication of the attention level of the operator (e.g., whether the user is in any physical pain, whether the operator is suffering from any sudden health conditions or change in physical wellbeing, etc.).

In various embodiments, information regarding the surrounding environment of the operator may be provided by one or more of the sensors or equipment described above and may be used to assess the attention level of the operator. Alternatively, or in addition, other sensors, equipment, devices, or resources (e.g., servers, cameras, satellites, etc.) may be used to collect information regarding the operator or the environment regarding the operator, or the robotic vehicle, and may be used for determining the attention level of the operator. In some examples, such information may include, but are not limited to, certain changes in the surrounding of the operator that may lead to a change in the attention level of the operator such as changes in weather, presence of other individuals, presence of sounds or events that may distract the operator, etc.

In some example embodiments, sensors or other equipment of the robotic vehicle may provide information regarding the behavior of the robotic vehicle or the environmental conditions of the robotic vehicle which may be used to determine the attention level of the operator. In some examples, such information may include, but are not limited to, information regarding certain behaviors of the robotic vehicle that may provide an indication of the attention level of the operator and/or that the operator attention level is below an acceptable level (i.e., the control commands provided by the operator are causing the robotic vehicle to behave in a way that indicates the operator is distracted). Such behaviors may include behaviors that deviate from normal or expected behaviors. For example, such deviations may include the robotic vehicle moving in an erratic manner, diverting from its path, and/or behaving in an unexpected manner (e.g., based on historical information) based on control commands from the operator.

In some examples, one or more remote sources may further provide information regarding the attention level of the operator. For example, one or more sources may provide information regarding historical behavior or conditions of the operator, robotic vehicle, and/or their surrounding environments.

The one or more processors may then determine that the attention level of the operator is below an acceptable level. In some example, an attention level of the operator may be determined, for example, based on various information regarding the operator or robotic vehicle, as described above. The one or more processors may then compare the determined attention level of the operator to an acceptable level. In some embodiments, the acceptable attention level for an operator may be defined as a threshold value or level of activity. In various embodiments, the acceptable level may be a user or system defined threshold. In some examples, the threshold may be may be defined based on information regarding the operator including the experience level of the operator, the type of robotic vehicle, etc. In other examples, the threshold may be defined and/or adjusted based on the current conditions surrounding the operator or robotic vehicle (e.g., conditions or the robotic vehicle, resources of the robotic vehicle, environmental conditions, etc.).

In some embodiments, the acceptable attention level may be defined in terms of activities or indications that indicate that the operator is below a desired level for safe and/or efficient control of the robotic vehicle. For example, as described above, one or more processors may determine that the user is engaged in a phone call or other activity (e.g., engaged with other applications on a UE, or other device), that indicate that the attention level of the operator is below an acceptable level and thus diverted from the operation of the robotic vehicle in a safe and/or efficient manner. For example, one or more sensors or other equipment (e.g., at a controller of the robotic vehicle, operator UE or other source) may provide information regarding the activities of the operator. As an example, where the activity is the operator being engaged in a phone call, the sensors or equipment may detect a conversation using information from the phone, gestures associated with a phone call using various sensors or cameras, and/or the orientation/position of the phone (e.g., the phone being held to an ear). In some examples, changes in user condition and/or environmental conditions may also be detected that indicated that the attention level of the operator is below a certain level for controlling the robotic vehicle in a safe and/or efficient manner. In other examples, one or more processors may detect a change in behaviors of the robotic vehicle in such a way that indicates that the attention level of the operator is diverted from the operation of the robotic vehicle in a safe and/or efficient manner (i.e., below an acceptable level).

In various embodiments, one or more processors may be configured to automatically control the robotic vehicle in response to detecting that the attention level of the operator is below an acceptable level. In some examples, automatically controlling the robotic vehicle may include overriding the operator control of the robotic vehicle, in whole or in part. In some example, automatically controlling the robotic vehicle may include the robotic vehicle entering an autonomous mode. In other examples, the robotic vehicle may communicate with a different entity or server to receive commands regarding actions to take once the operator control of the robotic vehicle is overridden. In some examples, automatic control of the robotic vehicle may include, but is not limited to, engaging a hover mode, landing the robotic vehicle (e.g., straight down, designated location, return to home/operator, go to charging location), engaging an autopilot mode, causing the robotic vehicle to fly in a straight line, holding pattern, or other predetermined course/pattern, controlling (enable/disable) some features of the robotic vehicle (e.g., enable obstacle detection; increase rate of sampling for obstacle detection; disable camera; change sensitivity of controls; restrict speed and/or maneuverability; disable one or more commands; etcf.), switching control to a third party, emitting some notification or alarm (e.g., “hazard lights”) to nearby people (operators/non-operators), drones, aircrafts, etc. indicating an inattentive operator, or perform some other predetermined action. In some embodiments, the automatic control of the robotic vehicle may be based on, but not limited to, one or more of default or system settings, user preferences, or contextual information such as robotic vehicle conditions (e.g., battery life, location, hazards or obstacles, population density, time, indoor versus outdoor, object density, etc.) and/or operator level of attention.

In some examples, when it is determined that the attention level of the operator is below an acceptable level, before automatically controlling the robotic vehicle, one or more processors may be configured to determine if control of the robotic vehicle should be switched from the operator control to automatically controlling the robotic vehicle. For example, a notification may be provided to the operator (e.g., at the controller or operator UE) indicating that the operator attention level is below an acceptable level and/or that the robotic vehicle is about to be automatically controlled. As a result, the operator may override the automatic control or may otherwise indicate that switching to automatically controlling the robotic vehicle is not necessary or desired at this time. In another example, presence of conditions that indicate that the attention level of the operator is not impacted despite the conditions indicating a fall below an acceptable level may indicate whether to switch to automatic control (e.g., the presence of another individual to keep an eye on the robotic vehicle while the user is engaged in other activity, user of equipment such as a Bluetooth headset, experience level of the operator, certain clearance, license, or permission granted to the operator and/or the robotic vehicle, a low density of objects nearby to which the robotic vehicle could impact, etc.).

In other examples, user or system settings may exist that indicate whether to switch to automatic control and/or before switching to automatic control, such settings may be checked. In other examples, certain conditions (e.g., malfunctions at the robotic vehicle, resources of the robotic vehicle, weather conditions, etc.) may indicate that despite the operator attention level, it may not be desirable to switch to automatically controlling the robotic vehicle. If it is determined that the robotic vehicle should not be automatically controlled, one or more processors may continue to monitor the attention level of the operator (or other conditions) while still allowing the operator to control the robotic vehicle. If, on the other hand, it is determined that the robotic vehicle should be automatically controlled, one or more processors may cause the robotic vehicle to be automatically controlled as described.

Once the robotic vehicle is being automatically controlled, the attention level of the operator may be monitored. If it is determined that the attention level of the operator is above an acceptable level, then one or more processors may be configured to cause the control of the robotic vehicle to be returned to the operator. If, however, the attention level of the operator is not above the acceptable level, the robotic vehicle may continue to be controlled automatically (i.e., without operator intervention).

In some embodiments, the duration of time from the switching of the control to automatic control may be tracked, and the automatic control of the robotic vehicle may be adjusted based on the duration. For example, for a first duration of time, automatically controlling the vehicle may include hovering the vehicle or continuing along the planned path, or in a straight line, but after a certain duration (greater than the first duration) automatic control of the robotic vehicle may cause the robotic vehicle to land (e.g., to conserve battery). Additionally, as described above, the operator level of attention or changes in operator level of attention may be detected while monitoring for the attention level of the operator. If, during automatic control of the robotic vehicle, a change in types of activity or operator level of the attention is detected, in various embodiments, automatic control of the robotic vehicle may be modified to address such changes (e.g., increase level of notification to operator to try and raise the attention level of the operator). In some examples, while being automatically controlled, if the attention level of the operator changes (e.g., while still under an acceptable level), automatic control of the robotic vehicle may be adjusted based on the chang in attention level of the operator (e.g., increase level of notification to operator to try and raise the attention level of the operator, land the robotic vehicle, etc.). For example, if the attention level of the operator falls further below the threshold (e.g., operator engages in additional distracting activities, or other conditions lead to further distractions, etc.), one or more additional or alternative actions may be performed as part of automatically controlling the vehicle to address the change in attention level.

Therefore, one or more processors may be configured to automatically control a robotic vehicle based on attention level of the operator and therefore may ensure that operator inattentiveness causes minimal impact to the drone, bystanders, and property and/or may conserve battery life until the operator can provide his/her undivided attention again, thus increasing the aggregate user experience for the operator.

Various embodiments provide systems and methods for addressing distraction event(s) while the robotic vehicle is receiving remote commands from an operator to control one or more operations of the robotic vehicle. A distraction event may be detected when an operator of the robotic vehicle engages in one or more other actions while controlling the robotic vehicle. For example, while controlling the robotic vehicle, the operator may engage in a phone call, text, email, chat or other message or conversation, or may engage with other applications (e.g., games). Such engagement in activities other than controlling the robotic vehicle may distract the operator such that the operator is unable to operate the robotic vehicle in a safe and efficient manner. Therefore, it is beneficial to provide a mechanism for overriding control of the robotic vehicle based on detecting distraction events while the operator is controlling the robotic vehicle.

In various embodiments, systems and methods are provided for detecting a distraction event while an operator is controlling a robotic vehicle and automatically controlling the robotic vehicle based on detection of the distraction event. In some examples, in response to an occurrence of a distraction event, one or more processors may receive an indication of a distraction event. In some examples, one or more processors may be configured to monitor the activities of the operator while the operator is controlling the robotic vehicle and may detect a distraction event.

Activities of the operator may be monitored using one or more sensors or other equipment. For example, sensors or other equipment (e.g., cameras) of the controller of the robotic vehicle used by the operator may be used to monitor the attention level of the operator. Such sensors or other equipment may provide information or indications of activities the operator is engaged in while controlling the robotic vehicle.

In some embodiments, the operator may be associated with one or more user equipment (UE) and at least one UE may provide information regarding the activities of the user, including activities the user engages in while the user is controlling the robotic vehicle. In some examples, the UE may also act as the controller of the robotic vehicle while in other examples, the UE may be separate from and/or optionally in communication with the controller of the robotic vehicle. Examples of UEs include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, or any other similar functioning device. In some example, the UE may include sensors and other equipment (e.g., cameras) that may provide information regarding the operator (e.g., similar to those described above).

For example, the UE may include one or more services or applications and may provide information regarding operator engagement with such services or applications. In some examples, indications of the operator engaging in certain activities (e.g., answering a phone call, engaging in conversation, engaging with one or more other devices or applications, etc.) may be provided to or detected by one or more processors. Such indications may include information from the controller or UE, such as information regarding the applications at the UE the user is engaged with such as an incoming/outgoing phone call, message or conversation (e.g., text, email or chat), or engagement with other applications. In some examples, the information picked up by one or more sensors or equipment such as cameras or microphones (e.g., conversations on the phone or nearby person, orientation of the UE or controller, gestures of the operator associate with certain activities, etc.) may also provide indications of one or more activities of the user.

In some examples, the one or more processors may detect a distraction event. In some examples, a distraction event is detected when one or more processors determine that the operator of the robotic vehicle is engaged in an activity other than controlling the robotic vehicle.

In various embodiments, one or more processors may be configured to automatically control the robotic vehicle in response to detecting the distraction event. In some examples, automatically controlling the robotic vehicle may include overriding the operator control of the robotic vehicle, in whole or in part. In some example, automatically controlling the robotic vehicle may include the robotic vehicle entering an autonomous mode. In other examples, the robotic vehicle may communicate with a different entity or server to receive commands regarding actions to take once the operator control of the robotic vehicle is overridden.

In some examples, automatic control of the robotic vehicle may include, but is not limited to, engaging a hover mode, landing the robotic vehicle (e.g., straight down, designated location, return to home/operator, go to charging location), engaging an autopilot mode, causing the robotic vehicle to fly in a straight line, holding pattern, or other predetermined course/pattern, controlling (enable/disable) some features of the robotic vehicle (e.g., enable obstacle detection; increase rate of sampling for obstacle detection; disable camera; change sensitivity of controls; restrict speed and/or maneuverability; disable one or more commands; etc.), switching control to a third party, emitting some notification or alarm (e.g., “hazard lights”) to nearby people (operators/non-operators), drones, aircrafts, etc. indicating an inattentive operator, or perform some other predetermined action. In some embodiments, the automatic control of the robotic vehicle may be based on, but not limited to, one or more of default or system settings, user preferences, or contextual information such as robotic vehicle conditions (e.g., battery life, location, hazards or obstacles, population density, time, indoor versus outdoor, object density, etc.) and/or operator level of attention.

In some examples, in response to detecting a distraction event while the operator is controlling the robotic vehicle, one or more processors may be configured to determine if control of the robotic vehicle should be switched from the operator control to automatically controlling the robotic vehicle. For example, a notification may be provided to the operator (e.g., at the controller or operator UE) indicating that a distraction event has been detected and/or that the robotic vehicle is about to be automatically controlled. In some examples, the operator may override the automatic control or may otherwise indicate that switching to automatically controlling the robotic vehicle is not necessary or desired at this time. In another example, presence of conditions that indicate that the operator is still operating the robotic vehicle in a safe or efficient manner despite the distraction event may indicate whether to switch to automatic control (e.g., the presence of another individual to keep an eye on the robotic vehicle while the user is engaged in other activity, user of equipment such as a Bluetooth headset, experience level of the operator, certain clearance, license, or permission granted to the operator and/or the robotic vehicle, a low density of objects nearby to which the robotic vehicle could impact, etc.).

In other examples, user or system settings may exist that indicate whether to switch to automatic control. In some examples, before switching to automatic control, such settings may be checked. In other examples, certain conditions (e.g., malfunctions at the robotic vehicle, resources of the robotic vehicle, weather conditions, etc.) may indicate that despite the distraction event, it may not be desirable to switch to automatically controlling the robotic vehicle. If it is determined that the robotic vehicle should not be automatically controlled, one or more processors may continue to monitor the attention level of the operator (or other conditions) while still allowing the operator to control the robotic vehicle. If, on the other hand, it is determined that the robotic vehicle should be automatically controlled, one or more processors may cause the robotic vehicle to be automatically controlled as described.

Once the robotic vehicle is being automatically controlled, one or more processor may be configured to determine if the distraction event has ended. In some examples, one or more processors may receive an indication that the activity corresponding to the distraction event has ended. For example, the operator may hang up a call, stop a conversation or exit out of or put an application on the background. If it is determined that the distraction event has ended, then one or more processors may be configured to cause the control of the robotic vehicle to be returned to the operator. If, however, the distraction event has not ended, the robotic vehicle may continue to be controlled automatically (i.e., without operator intervention). In some examples, if one or more processors determine that the distraction event has not ended, the one or more processors may determine if one or more modifications to automatically controlling the robotic vehicle need to be made.

In some examples, in response to determining that the distraction event has not ended, one or more processors may determine if an additional distraction event (e.g., additional operator activities that distract the operator) is detected. In various embodiments, automatic control of the robotic vehicle may be modified in response to determining that an additional distraction event has been detected. For example, one or more processors may be configured to cause an increase in the level of notification to operator. In some examples, one or more additional or alternative actions may be performed as part of automatically controlling the vehicle to address the additional distraction event (e.g., landing the robotic vehicle instead of hovering, etc.).

In some embodiments, one or more processors may track the duration of time of the distraction event, and the automatic control of the robotic vehicle may be adjusted based on the duration. For example, for a first duration of time, automatically controlling the vehicle may include hovering the vehicle or continuing along the planned path, or in a straight line, but after a certain duration (greater than the first duration) automatic control of the robotic vehicle may cause the robotic vehicle to land (e.g., to conserve battery).

Therefore, one or more processors may be configured to automatically control a robotic vehicle in response to detecting a distraction event and therefore may ensure that operator inattentiveness causes minimal impact to the drone, bystanders, and property and/or may conserve battery life until the operator can provide his/her undivided attention again, thus increasing the aggregate user experience for the operator.

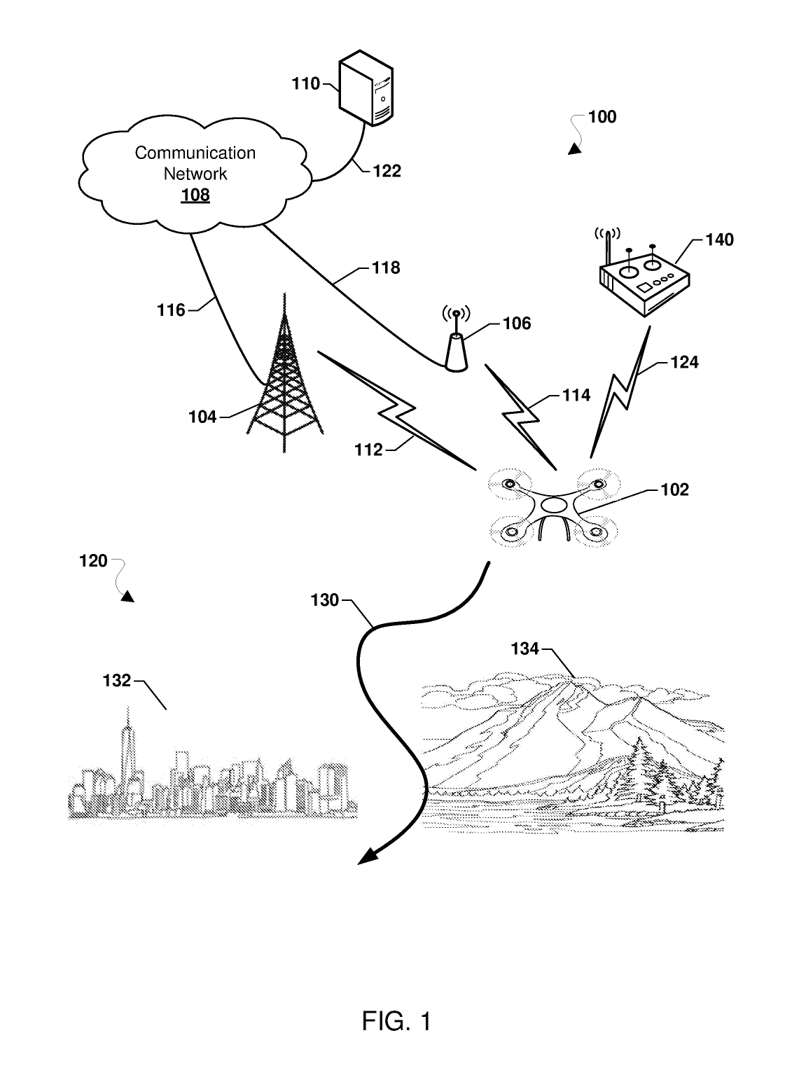

Various embodiments may be implemented within a robotic vehicle operating within a variety of communication systems 100, an example of which is illustrated in FIG. 1. With reference to FIG. 1, the communication system 100 may include a robotic vehicle 102, a base station 104, an access point 106, a communication network 108, and a network element 110.

The base station 104 and the access point 106 may provide wireless communications to access the communication network 108 over a wired and/or wireless communication backhaul 116 and 118, respectively. The base station 104 may include base stations configured to provide wireless communications over a wide area (e.g., macro cells), as well as small cells, which may include a micro cell, a femto cell, a pico cell, and other similar network access points. The access point 106 may be configured to provide wireless communications over a relatively smaller area. Other examples of base stations and access points are also possible.

The vehicle 102 may communicate with the robotic vehicle controller 140 over a wireless communication link 116. The robotic vehicle controller 140 may provide flight and/or navigation instructions to the vehicle 102. The robotic vehicle 102 may communicate with the base station 104 over a wireless communication link 112 and with the access point 106 over a wireless communication link 114. The wireless communication links 112 and 114 may include a plurality of carrier signals, frequencies, or frequency bands, each of which may include a plurality of logical channels. The wireless communication links 112 and 114 may utilize one or more radio access technologies (RATs). Examples of RATs that may be used in a wireless communication link include 3GPP Long Term Evolution (LTE), 3G, 4G, 5G, Global System for Mobility (GSM), Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi, LTE-U, LTE-Direct, LAA, MuLTEfire, and relatively short-range RATs such as ZigBee, Bluetooth, and Bluetooth Low Energy (LE).

The network element 110 may include a network server or another similar network element. The network element 110 may communicate with the communication network 108 over a communication link 122. The robotic vehicle 102 and the network element 110 may communicate via the communication network 108. The network element 110 may provide the robotic vehicle 102 with a variety of information, such as navigation information, weather information, information about environmental conditions, movement control instructions, safe landing zones, and other information, instructions, or commands relevant to operations of the robotic vehicle 102.

In various embodiments, the robotic vehicle 102 may move in, around, or through an environment 120 along a path of travel 130. The environment 120 may include a variety of terrain, such as an urban terrain 132, a natural terrain 134, and the like. While travelling along the path of travel 130 the robotic vehicle 102 may receive various flight and/or navigation instructions from an operator via the robotic vehicle controller 140. In various embodiments, based on an attention level of the operator and/or in response to detecting a distraction event while the operator is controlling the vehicle using the robotic vehicle controller 140, the robotic vehicle 102 may be configured to automatically control the robotic vehicle.

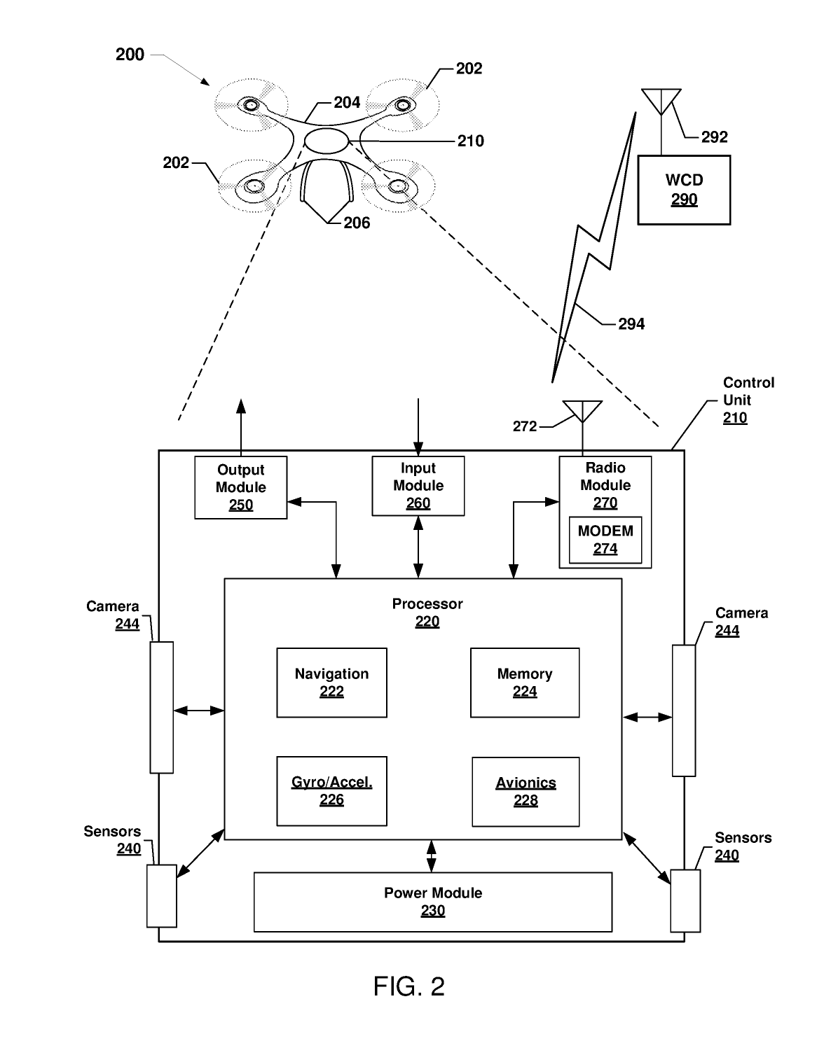

Robotic vehicles may include winged or rotorcraft varieties of aerial robotic vehicles. FIG. 2 illustrates an example of an aerial robotic vehicle 200 that utilizes multiple rotors 202 driven by corresponding motors to provide lift-off (or take-off) as well as other aerial movements (e.g., forward progression, ascension, descending, lateral movements, tilting, rotating, etc.). The robotic vehicle 200 is illustrated as an example of a robotic vehicle that may utilize various embodiments, but is not intended to imply or require that various embodiments are limited to aerial robotic vehicles or rotorcraft robotic vehicles. Various embodiments may be used with winged robotic vehicles, land-based autonomous vehicles, water-borne autonomous vehicles, and space-based autonomous vehicles.

With reference to FIGS. 1 and 2, the robotic vehicle 200 may be similar to the robotic vehicle 102. The robotic vehicle 200 may include a number of rotors 202, a frame 204, and landing columns 206 or skids. The frame 204 may provide structural support for the motors associated with the rotors 202. The landing columns 206 may support the maximum load weight for the combination of the components of the robotic vehicle 200 and, in some cases, a payload. For ease of description and illustration, some detailed aspects of the robotic vehicle 200 are omitted such as wiring, frame structure interconnects, or other features that would be known to one of skill in the art. For example, while the robotic vehicle 200 is shown and described as having a frame 204 having a number of support members or frame structures, the robotic vehicle 200 may be constructed using a molded frame in which support is obtained through the molded structure. While the illustrated robotic vehicle 200 has four rotors 202, this is merely exemplary and various embodiments may include more or fewer than four rotors 202.

The robotic vehicle 200 may further include a control unit 210 that may house various circuits and devices used to power and control the operation of the robotic vehicle 200. The control unit 210 may include a processor 220, a power module 230, sensors 240, one or more cameras 244, an output module 250, an input module 260, and a radio module 270.

The processor 220 may be configured with processor-executable instructions to control travel and other operations of the robotic vehicle 200, including operations of various embodiments. The processor 220 may include or be coupled to a navigation unit 222, a memory 224, a gyro/accelerometer unit 226, and an avionics module 228. The processor 220 and/or the navigation unit 222 may be configured to communicate with a server through a wireless connection (e.g., a cellular data network) to receive data useful in navigation, provide real-time position reports, and assess data.

The avionics module 228 may be coupled to the processor 220 and/or the navigation unit 222, and may be configured to provide travel control-related information such as altitude, attitude, airspeed, heading, and similar information that the navigation unit 222 may use for navigation purposes, such as dead reckoning between Global Navigation Satellite System (GNSS) position updates. The gyro/accelerometer unit 226 may include an accelerometer, a gyroscope, an inertial sensor, or other similar sensors. The avionics module 228 may include or receive data from the gyro/accelerometer unit 226 that provides data regarding the orientation and accelerations of the robotic vehicle 200 that may be used in navigation and positioning calculations, as well as providing data used in various embodiments for processing images.

The processor 220 may further receive additional information from the sensors 240, such as an image sensor or optical sensor (e.g., a sensor capable of sensing visible light, infrared, ultraviolet, and/or other wavelengths of light). The sensors 240 may also include a radio frequency (RF) sensor, a barometer, a humidity sensor, a sonar emitter/detector, a radar emitter/detector, a microphone or another acoustic sensor, a lidar sensor, a time-of-flight (TOF) 3-D camera, or another sensor that may provide information usable by the processor 220 for movement operations, navigation and positioning calculations, and determining environmental conditions. The sensors 240 may be configured to monitor for and identify information for determining an attention level of the user and/or a distraction event while the operator is controlling the vehicle.

The power module 230 may include one or more batteries that may provide power to various components, including the processor 220, the sensors 240, the one or more cameras 244, the output module 250, the input module 260, and the radio module 270. In addition, the power module 230 may include energy storage components, such as rechargeable batteries. The processor 220 may be configured with processor-executable instructions to control the charging of the power module 230 (i.e., the storage of harvested energy), such as by executing a charging control algorithm using a charge control circuit. Alternatively, or additionally, the power module 230 may be configured to manage its own charging. The processor 220 may be coupled to the output module 250, which may output control signals for managing the motors that drive the rotors 202 and other components.

The robotic vehicle 200 may be controlled through control of the individual motors of the rotors 202 as the robotic vehicle 200 progresses toward a destination. The processor 220 may receive data from the navigation unit 222 and use such data in order to determine the present position and orientation of the robotic vehicle 200, as well as the appropriate course towards the destination or intermediate sites. In various embodiments, the navigation unit 222 may include a GNSS receiver system (e.g., one or more global positioning system (GPS) receivers) enabling the robotic vehicle 200 to navigate using GNSS signals. Alternatively, or in addition, the navigation unit 222 may be equipped with radio navigation receivers for receiving navigation beacons or other signals from radio nodes, such as navigation beacons (e.g., very high frequency (VHF) omni-directional range (VOR) beacons), Wi-Fi access points, cellular network sites, radio station, remote computing devices, other robotic vehicles, etc.

The radio module 270 may be configured to receive navigation signals, such as signals from a remote controller of an operator or navigation facilities, etc., and provide such signals to the processor 220 and/or the navigation unit 222 to assist in robotic vehicle navigation. In various embodiments, the navigation unit 222 may use signals received from recognizable RF emitters (e.g., AM/FM radio stations, Wi-Fi access points, and cellular network base stations) on the ground.

The radio module 270 may include a modem 274 and a transmit/receive antenna 272. The radio module 270 may be configured to conduct wireless communications with a variety of wireless communication devices (e.g., a wireless communication device (WCD) 290), examples of which include a robotic vehicle controller (e.g., robotic vehicle controller 140), a wireless telephony base station or cell tower (e.g., the base station 104), a network access point (e.g., the access point 106), a beacon, a smartphone, a tablet, another robotic vehicle, or another computing device with which the robotic vehicle 200 may communicate (such as the network element 110). The processor 220 may establish a bi-directional wireless communication link 294 via the modem 274 and the antenna 272 of the radio module 270 and the wireless communication device 290 via a transmit/receive antenna 292. In some embodiments, the radio module 270 may be configured to support multiple connections with different wireless communication devices using different radio access technologies.

In various embodiments, the wireless communication device 290 may be connected to a server through intermediate access points. In an example, the wireless communication device 290 may be a user equipment of a robotic vehicle operator, a server of a robotic vehicle operator, a third-party service (e.g., package delivery, billing, etc.), a site communication access point, or any combination thereof. The robotic vehicle 200 may communicate with the wireless communication device 290 through one or more intermediate communication links, such as a wireless telephony network that is coupled to a wide area network (e.g., the Internet) or other communication devices. In some embodiments, the robotic vehicle 200 may include and employ other forms of radio communication, such as mesh connections with other robotic vehicles or connections to other information sources (e.g., balloons or other stations for collecting and/or distributing weather or other data harvesting information).

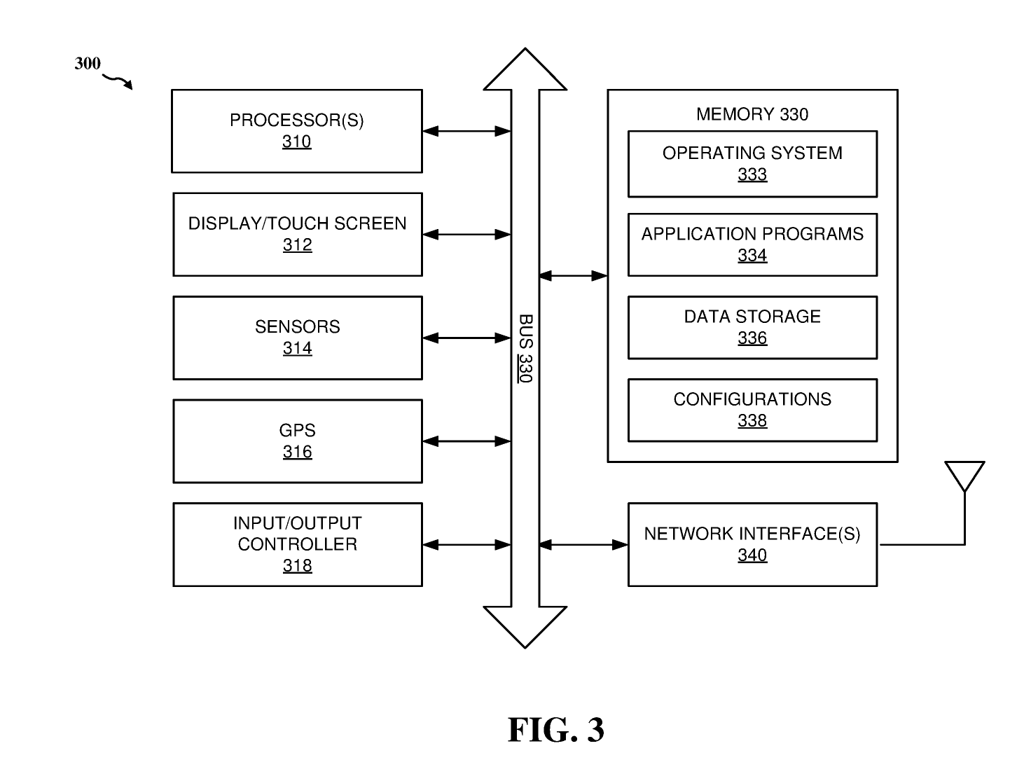

In various embodiments, the wireless communication device 290 may be implemented as a UE of an operator such as example electronic device 300 (e.g., described in more detail with respect to FIG. 3). In some examples, the wireless communication device 290 may provide one or more operator commands to the control unit 210 (via radio module 270) for controlling one or more operations of the robotic vehicle. Example control operations provided by the wireless communication device 290 may include, but are not limited to, flight and/or navigation instructions or commands. In some examples, in addition to flight and/or navigation commands, the communication device 290 may further provide other information including, but not limited to, information regarding the operator, or environmental conditions surrounding the operator, operator attention level information, information regarding activities of the operator and/or presence of distraction event to the control unit 210. In some embodiments, the control unit 210 may include an operator control override application for controlling the robotic vehicle based on an attention level of the operator of the vehicle, and/or detection of a distraction event at the wireless communication device 290.

In various embodiments, the control unit 210 may be equipped with an input module 260, which may be used for a variety of applications. For example, the input module 260 may receive images or data from an onboard camera 244 or sensor, or may receive electronic signals from other components (e.g., a payload).

While various components of the control unit 210 are illustrated as separate components, some or all of the components (e.g., the processor 220, the output module 250, the radio module 270, and other units) may be integrated together in a single device or module, such as a system-on-chip module.

FIG. 3 is a block diagram illustrating components of an example electronic device 300 for implementing a wireless communication device (e.g., robotic vehicle controller 140 and wireless communication device 290 of FIGS. 1 and 2, respectively). With reference to FIGS. 1-3, in some embodiments, the example electronic device may be a user equipment (UE). Examples of UEs include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a controller (e.g., robotic device controller), a smart device, a wearable device, or any other similar functioning device. The UE may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The computing device architecture of the electronic device 300 may include one or more processors 310, a memory 320, which may include volatile storage, such as random-access memory (“RAM”), and non-volatile storage, such as read-only memory (“ROM”), and a system bus 330 that couples the memory 320 and other components to the one or more processors 310. The memory 320 may further stores an operating system 322, application programs 324, such as, but not limited to, calendar applications, reminder applications, communication applications, web browsers, and/or conflict detection application, a data repository 326 for storing application data, such as event information and/or conflict notifications, and device configurations 328 for configuring various functionalities of the computing device. Other application programs and data may also be stored in memory 320. The memory 320 may be connected to the one or more processors 310 through a controller (not shown in FIG. 3), which in turn is connected to the system bus 330.

The electronic device 300 may connect to the network through one or more network interfaces 340, which are also coupled to the bus 330. The network interfaces 340 may include a radio interface for wireless local area network (LAN) based on IEEE 802.11 standards. It should be appreciated that the one or more network interfaces may also utilize a variety of wired and/or wireless technologies to connect to other types of networks and remote computer systems.

An input/output controller 318 may be used for receiving and processing input from a number of devices, such as keys, buttons, stylus, and interfaces for connecting a keyboard and/or a mouse (not shown in FIG. 3). Similarly, the input/output controller 318 may provide output to a display screen or some other type of output device. In some implementations, the computing device may incorporate a touch screen display 312, which may display information and receive input, including text, commands, and control information.

The electronic device 300 may include one or more sensors 314 for capturing user activity information, biometric information, images, and videos, among other information. The one or more sensors 314 may include motion sensors, such as an accelerometer for measuring acceleration, a gyroscope for measuring orientation, or a combination thereof. Alternatively, or in addition, the one or more sensors 314 may include biometric sensors for obtaining the user's biometric information, such as heart rate, blood pressure, and skin colorization. The electronic device 300 may also include one or more cameras, such as photo cameras or video cameras, for voice/video messaging, voice/video conferencing, and/or recording images, voice information or videos relating to the user's activities.

The electronic device 300 may also incorporate a GPS module 316 capable of receiving GPS signals and determining a location of the electronic device 300. The electronic device 300 may also incorporate an audio interface, such as a microphone, a speaker, and an earphone port, for effecting voice communications and voice control functions. The electronic device 300 may also incorporate one or more visual indicators, such as LEDs.

It should be appreciated that the software components described herein may, when loaded into the one or more processors 310 and executed, transform the processors 310 and the overall electronic device 300 from a general-purpose computing system into a special-purpose computing system customized to facilitate the functionality presented herein. More specifically, the processors 310 may operate as a finite-state machine, in response to executable instructions contained within the software modules disclosed herein. These computer-executable instructions may transition the processors 310 between states.

It also should be appreciated that the electronic device 300 may include other types of computing devices, including server computers, desktop computers, embedded computer systems, e-book readers, set-top boxes, personal digital assistants, and other types of computing devices operative to provide location and activity based smart reminder on a user device in accordance with aspects of the disclosure herein. The electronic device 300 may not include all of the components shown in FIG. 3, may include other components that are not explicitly shown in FIG. 3, or may utilize an architecture different than that shown in FIG. 3.

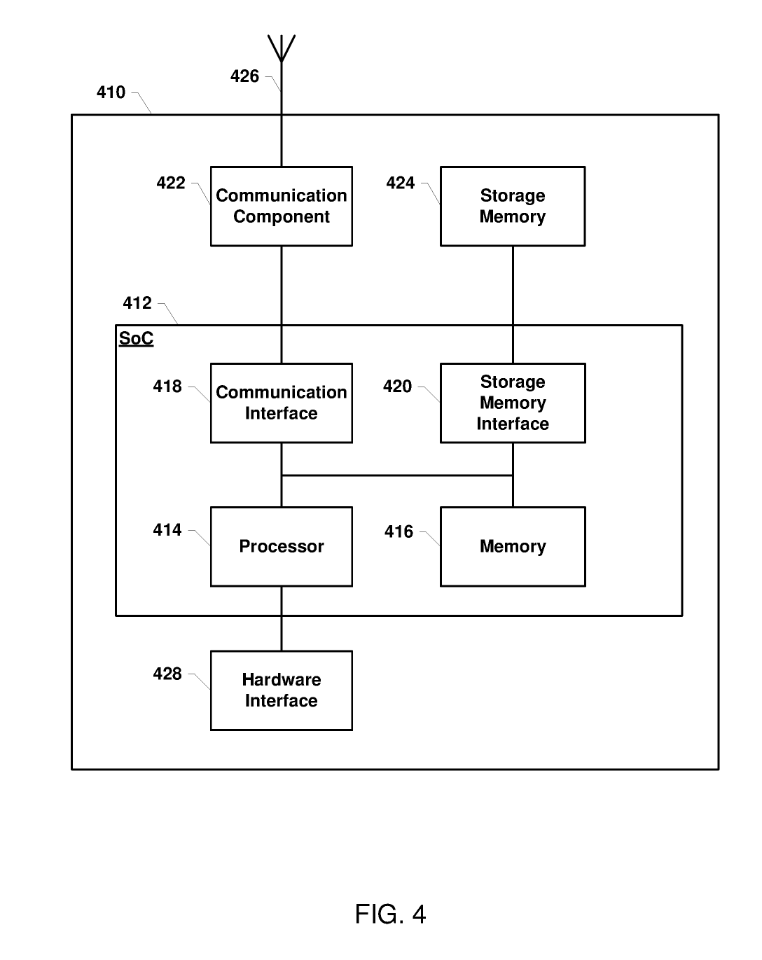

Various embodiments may be implemented within a processing device 410 configured to be used in wireless communication device or a robotic vehicle. A processing device may be configured as or including a system-on-chip (SOC) 412, an example of which is illustrated FIG. 4. With reference to FIGS. 1-4, the SOC 412 may include (but is not limited to) a processor 414, a memory 416, a communication interface 418, and a storage memory interface 420. The processing device 410 or the SOC 412 may further include a communication component 422, such as a wired or wireless modem, a storage memory 424, an antenna 426 for establishing a wireless communication link, and/or the like. The processing device 410 or the SOC 412 may further include a hardware interface 428 configured to enable the processor 414 to communicate with and control various components of a robotic vehicle. The processor 414 may include any of a variety of processing devices, for example any number of processor cores.

The term “system-on-chip” (SOC) is used herein to refer to a set of interconnected electronic circuits typically, but not exclusively, including one or more processors (e.g., 414), a memory (e.g., 416), and a communication interface (e.g., 418). The SOC 412 may include a variety of different types of processors 414 and processor cores, such as a general purpose processor, a central processing unit (CPU), a digital signal processor (DSP), a graphics processing unit (GPU), an accelerated processing unit (APU), a subsystem processor of specific components of the processing device, such as an image processor for a camera subsystem or a display processor for a display, an auxiliary processor, a single-core processor, and a multicore processor. The SOC 412 may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

The SOC 412 may include one or more processors 414. The processing device 410 may include more than one SOC 412, thereby increasing the number of processors 414 and processor cores. The processing device 410 may also include processors 414 that are not associated with an SOC 412 (i.e., external to the SOC 412). Individual processors 414 may be multicore processors. The processors 414 may each be configured for specific purposes that may be the same as or different from other processors 414 of the processing device 410 or SOC 412. One or more of the processors 414 and processor cores of the same or different configurations may be grouped together. A group of processors 414 or processor cores may be referred to as a multi-processor cluster.

The memory 416 of the SOC 412 may be a volatile or non-volatile memory configured for storing data and processor-executable instructions for access by the processor 414. The processing device 410 and/or SOC 412 may include one or more memories 416 configured for various purposes. One or more memories 416 may include volatile memories such as random-access memory (RAM) or main memory, or cache memory.

Some or all of the components of the processing device 410 and the SOC 412 may be arranged differently and/or combined while still serving the functions of the various aspects. The processing device 410 and the SOC 412 may not be limited to one of each of the components, and multiple instances of each component may be included in various configurations of the processing device 410.

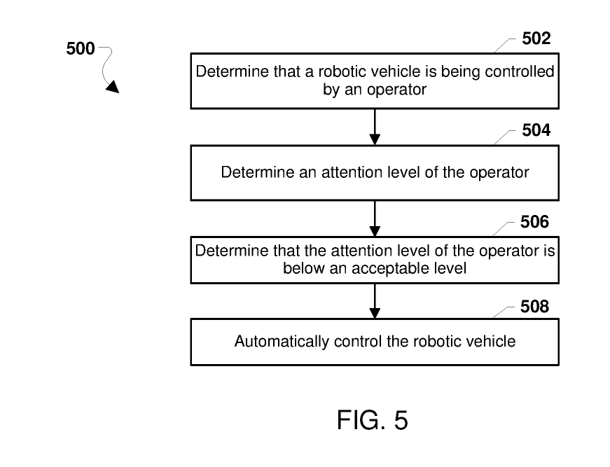

FIG. 5 illustrates an example method 500 for controlling operation of a robotic vehicle, according to various embodiments. With reference to FIGS. 1-5, the method 500 may be implemented in hardware components and/or software components of the robotic vehicle (e.g., 102, 200) and/or the wireless communication device (e.g., 290) the operation of which may be controlled by one or more processors (e.g., the processor 220, 310, 410, 414 and/or the like).

In block 502, one or more processors may determine that a robotic vehicle is being controlled by an operator. For example, the one or more processor may determine that the robotic vehicle is being controlled by the operator when the robotic vehicle is receiving one or more control commands from the operator. In other examples, the one or more processor may determine that the robotic vehicle is being controlled by the operator when the robotic vehicle is in a mode where it may be controlled by one or more commands from the operator. As another example, the robotic vehicle is being controlled by the operator when one or certain actions are performed by the operator (e.g., powering on the robotic vehicle, causing the robotic vehicle to take off, inputting a command, etc.).

In block 504, one or more processors may determine an attention level of the operator. In various embodiments, one or more processors may determine an attention level of the operator based on various information. In some examples, one or more processors may be configured to monitor the attention level of the operator and may determine an attention level of the operator during the monitoring. The attention level of the operator may be determined based on various information including, for example, the behavior of the operator, the environment of the operator, the behavior and/or environment of the robotic vehicle, and/or the like.

In some embodiments, the operator may be associated with one or more user equipment (UE) and the UE may provide information that may be used to determine the attention level of the operator. In some examples, the UE may also act as the controller of the robotic vehicle while in other examples, the UE may be separate from and/or optionally communicationally coupled to the controller of the robotic vehicle (e.g., via Bluetooth, WIFI, cellular, or other technology). In various embodiments, the UE may provide information regarding various activities of the operator with respect to the UE. For example, the UE may include one or more services or applications and may provide information regarding operator engagement with such services or applications that may be used to assess the attention level of the operator. For example, the information may include indications of the operator engaging in certain activities (e.g., answering a phone call, engaging in conversation, engaging with one or more other devices or applications, etc.). Such indications may include information from the controller or UE, such as information regarding the applications at the UE the user is engaged with (e.g., an incoming phone call), information picked up by one or more sensors or equipment such as cameras or microphones (e.g., conversations on the phone or nearby person, orientation of the UE or controller, gestures of the operator associate with certain activities, etc.).

In some examples, sensors or other equipment (e.g., cameras) of the controller of the robotic vehicle or other UE used by the operator may provide information such as the direction of the operator, the direction of the gaze of the operator, health condition of the operator (e.g., heart rate), activities the operator is engaged in, surrounding information of the operator, etc. In such examples, the location and/or direction of the gaze or body of the operator may also provide information regarding the attention level of the operator (e.g., if the user turns or looks away from the controller or the path of the robotic vehicle). In other examples, the physical characteristics of the operator may provide an indication of the attention level of the operator (e.g., whether the user is in any physical pain, whether the operator is suffering from any sudden health conditions or change in physical wellbeing, etc.). In some embodiments, such examples of information may be collected by the robotic vehicle in addition to or alternative of being collected by the controller.

In various embodiments, information regarding the surrounding environment of the operator may be provided by one or more of the sensors or equipment described and may be used to assess the attention level of the operator. Alternatively, or in addition, other sensors, equipment, devices, or resources (e.g., servers, cameras, satellites) may be used to collect information regarding the operator or the environment regarding the operator, or the robotic vehicle, and may be used for determining the attention level of the operator. In some examples, such information may include, but are not limited to, certain changes in the surrounding of the operator that may lead to a change in the attention level of the operator such as changes in weather, presence of other individuals, presence of sounds or events that may distract the operator, etc.

In some example embodiments, sensors or other equipment of the robotic vehicle may provide information regarding the behavior of the robotic vehicle or the environmental conditions of the robotic vehicle which may be used to determine the attention level of the operator. In some examples, such information may include, but are not limited to, information regarding certain behaviors of the robotic vehicle that may provide an indication of the attention level of the operator and/or that the operator attention level is below an acceptable level (i.e., the control commands provided by the operator are causing the robotic vehicle to behave in a way that indicates the operator is distracted). Such behaviors may include behaviors that deviate from normal or expected behaviors. For example, such deviations may include the robotic vehicle moving in an erratic manner, diverting from its path, and/or behaving in an unexpected manner (e.g., based on historical information) based on control commands from the operator.

In some examples, one or more remote sources may further provide information regarding the attention level of the operator. For example, one or more sources may provide information regarding historical behavior or conditions of the operator, robotic vehicle, and/or their surrounding environments.

In block 506, one or more processors may determine that the attention level of the operator is below an acceptable level. The one or more processors may compare the determined attention level of the operator, as determined in block 504, to an acceptable level. In some embodiments, the acceptable attention level for an operator may be defined as a threshold value or level of activity. In various embodiments, the acceptable level may be a user or system defined threshold. In some examples, the threshold may be defined based on information regarding the operator including the experience level of the operator, the type of robotic vehicle, etc. In some examples, the threshold may be defined and/or adjusted based on the current conditions surrounding the operator or robotic vehicle (e.g., conditions or the robotic vehicle, resources of the robotic vehicle, environmental conditions, etc.).

In some embodiments, the acceptable attention level may be defined in terms of activities or indications that indicate that the operator is below a desired level for safe and/or efficient control of the robotic vehicle. In some examples, changes in user condition and/or environmental conditions may also be detected that indicated that the attention level of the operator is below a certain level for controlling the robotic vehicle in a safe and/or efficient manner. In other examples, one or more processors may detect a change in behaviors of the robotic vehicle in such a way that indicates that the attention level of the operator is diverted from the operation of the robotic vehicle in a safe and/or efficient manner (i.e., below an acceptable level).

In block 508, one or more processors may automatically control the robotic vehicle. In some embodiments, a processor of the robotic vehicle may be configured to automatically control the robotic vehicle. In some embodiments, automatically controlling the robotic vehicle may be in response to determining that the attention level of the operator is below an acceptable level. In some examples, automatically controlling the robotic vehicle may include overriding the operator control of the robotic vehicle, in whole or in part. In some embodiments, automatically controlling the robotic vehicle may include the robotic vehicle entering an autonomous mode. In some embodiments, the robotic vehicle may communicate with a different entity or server to receive commands regarding actions to take once the operator control of the robotic vehicle is overridden. In some embodiments, automatic control of the robotic vehicle may include, but is not limited to, engaging a hover mode, landing the robotic vehicle (e.g., straight down, designated location, return to home/operator, go to charging location), engaging an autopilot mode, causing the robotic vehicle to fly in a straight line, holding pattern, or other predetermined course/pattern, controlling (enable/disable) some features of the robotic vehicle (e.g., enable obstacle detection; increase rate of sampling for obstacle detection; disable camera; change sensitivity of controls; restrict speed and/or maneuverability; disable one or more commands), switching control to a third party, emitting some notification or alarm (e.g., “hazard lights”) to nearby people (operators/non-operators), drones, aircrafts, etc. indicating an inattentive operator, or perform some other predetermined action. In some embodiments, the automatic control of the robotic vehicle may be based on, but not limited to, one or more of default or system settings, user preferences, or contextual information such as robotic vehicle conditions (e.g., battery life, location, hazards or obstacles, population density, time, etc.) and/or operator level of attention.

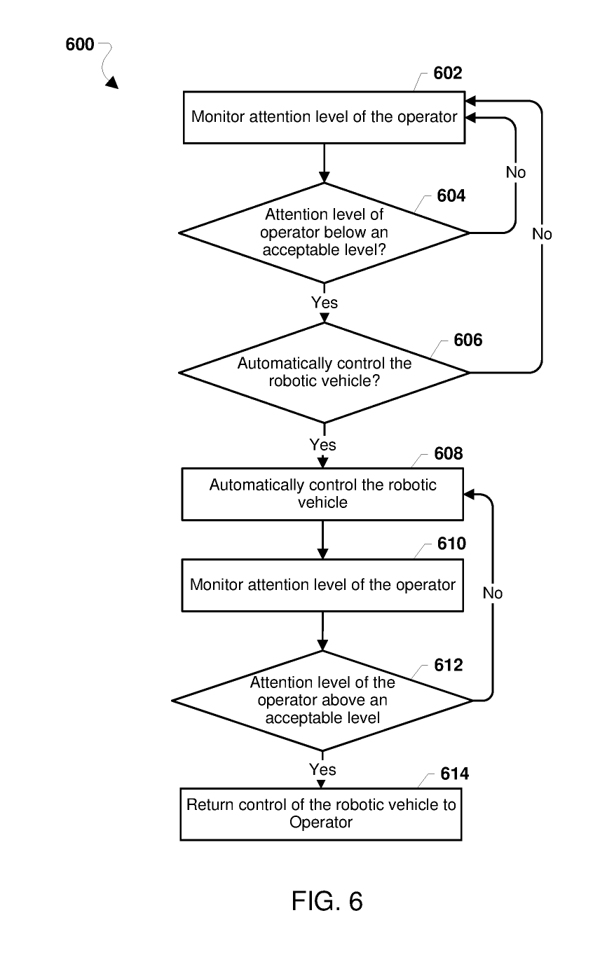

FIG. 6 illustrates an example method 600 for switching control of operation of a robotic vehicle based on an attention level of an operator, according to various embodiments. The method 600 includes operations that may be performed as part of determination blocks 502, 504, 506 and/or 508 (FIG. 5). With reference to FIGS. 1-6, the method 600 may be implemented in hardware components and/or software components of the robotic vehicle (e.g., 102, 200) and/or the wireless communication device (e.g., 290) the operation of which may be controlled by one or more processors (e.g., the processor 220, 310, 410, 414 and/or the like).

In block 602, the one or more processors may monitor the attention level of the operator. In various examples, the one or more processors may monitor the attention level of the operator if it is determined that the operator is controlling the robotic vehicle. For example, the attention level of the operator may be monitored once it is determined that the robotic vehicle is receiving one or more control commands from the operator. In other examples, monitoring of the attention level of the operator may occur when the robotic vehicle is in a mode where it may be controlled by one or more commands from the operator.

In some examples, monitoring of the attention level of the operator may occur in response to a triggering event. The triggering event may include events that indicate a need to begin monitoring the attention level of the operator while the operator is providing control commands to the robotic vehicle. Such triggers may include, but are not limited to, certain behaviors of the operator, environmental conditions surrounding the operator, certain behaviors of the robotic vehicle, and/or conditions of the robotic vehicle.

In some embodiments, behaviors of the operator may trigger monitoring for the attention level of the operator and may include, but are not limited to, receiving indications of the operator engaging in certain activities (e.g., answering a phone call, engaging in conversation, engaging with one or more other devices or applications, etc.). In some example, the location and/or direction of the gaze and/or body of the operator may also provide a trigger to begin monitoring for the attention level of the operator (e.g., if the operator turns or looks away from the controller or the path of the robotic vehicle). In other examples, the physical characteristics of the operator may provide triggers for beginning to monitor for the attention level of the operator (e.g., whether the user is in any physical pain, whether the operator is suffering from any sudden health conditions or change in physical wellbeing, etc.).

In some examples, the environment of the operator may also provide triggers for monitoring the attention level of the operator. For example, certain changes in the surrounding of the operator may lead to an increase in the chance of the attention level of the operator falling below an acceptable level. Such changes may include, but are not limited to, change in weather, presence of other individuals, presence of sounds or events that may distract the operator, etc.

In various embodiments, certain behaviors of the robotic vehicle may provide a trigger for monitoring the attention level of the operator. Such behaviors may for example include behaviors that may indicate that the operator attention level is below an acceptable level (i.e., the control commands provided by the operator are causing the robotic vehicle to behave in a way that indicates the operator is distracted). Such behaviors may include behaviors that deviate from normal or expected behaviors. For example, such deviations may include the robotic vehicle moving in an erratic manner, diverting from its path, and/or behaving in an unexpected manner (e.g., based on historical information) based on control commands from the operator.

Conditions of the robotic vehicle may also provide a trigger for monitoring the attention level of the operator. For example, changes in the environmental conditions of the robotic vehicle may provide such trigger (e.g., changes that require attention from the operator). In other examples, changes to the condition of the robotic vehicle, such as battery level or malfunction of mechanical parts may trigger monitoring for the attention level of the operator.

The attention level of the operator may be monitored using one or more sensors or other equipment. For example, sensors or other equipment (e.g., cameras) of the controller of the robotic vehicle used by the operator, a UE of the operator, the robotic vehicle, or other sensors or equipment at one or more other sources (e.g., environment surrounding the operator or robotic vehicle, remote server, etc.), may be used to monitor the attention level of the operator. Such sensors or other equipment may provide information such as the direction of the operator, the direction of the gaze of the operator, health condition of the operator, activities the operator is engaged in, surrounding information of the operator, etc.

In some embodiments, the operator may be associated with one or more UE, and the UE may provide information that may be used for monitoring the attention level of the operator. In some examples, the UE may also act as the controller of the robotic vehicle while in other examples, the UE may be separate from and/or optionally in communication with the controller of the robotic vehicle. In some example, the UE may include sensors and other equipment (e.g., cameras) that may provide information regarding the operator (e.g., similar to those described).

In some examples, monitoring the attention level of the operator may include determining the attention level of the operator (e.g., periodically, or continuously). In various embodiments, one or more processors may determine an attention level of the operator based on various information, including, but not limited, the behavior of the operator, the environment of the operator, and/or the behavior and/or environment of the robotic vehicle. In some embodiments, the determination of the attention level of the operator may be performed as described in block 502.

In block 604, one or more processors may determine if the attention level of the operator is below an acceptable level. For example, in some embodiments, in response to monitoring for the attention level of the operator, one or more processors may determine an attention level of the operator based on various information regarding the operator or robotic vehicle, as described above. In some embodiments, the determination may be similar to the process described above with respect to block 504.

The one or more processors may then compare the determined attention level of the operator to an acceptable level. In some embodiments, the acceptable attention level for an operator may be defined as a threshold value or level of activity. In various embodiments, the acceptable level may be a user or system defined threshold. In some examples, the threshold may be may be defined based on information regarding the operator including the experience level of the operator, the type of robotic vehicle, etc. In other examples, the threshold may be defined and/or adjusted based on the current conditions surrounding the operator or robotic vehicle (e.g., conditions or the robotic vehicle, resources of the robotic vehicle, environmental conditions, etc.).

In some embodiments, the acceptable attention level may be defined in terms of activities or indications that indicate that the operator is below a desired level for safe and/or efficient control of the robotic vehicle. For example, as described above, one or more processors may determine that the user is engaged in a phone call or other activity (e.g., engaged with other applications on a UE, or other device), that indicate that the attention level of the operator is below an acceptable level and thus diverted from the operation of the robotic vehicle in a safe and/or efficient manner. For example, one or more sensors or other equipment (e.g., at a controller of the robotic vehicle, operator UE or other source) may provide information regarding the activities of the operator. As an example, where the activity is the operator being engaged in a phone call, the sensors or equipment may detect a call is being received (and answered), a conversation using information from the phone, gestures associated with a phone call using various sensors or cameras, and/or the orientation/position of the phone (e.g., the phone being held to an ear). In some examples, changes in user condition and/or environmental conditions may also be detected that indicated that the attention level of the operator is below a certain level required for controlling the robotic vehicle in a safe and/or efficient manner. In other examples, one or more processors may detect a change in behaviors of the robotic vehicle in such a way that indicates that the attention level of the operator is diverted from the operation of the robotic vehicle in a safe and/or efficient manner (i.e., below an acceptable level).

In some examples, if the attention level of the operator is above an acceptable level (determination step 604=No), the one or more processors may continue to monitor the attention level of the operator in block 602 (e.g., for some amount of time or continuously). Otherwise, if the attention level of the operator is below an acceptable level (determination step 604=Yes), then in block 606, it is determined whether to automatically control the robotic vehicle. For example, a notification may be provided to the operator (e.g., at the controller or operator UE) indicating that the operator attention level is below an acceptable level and/or that the robotic vehicle is about to be automatically controlled. As a result, the operator may override the automatic control or may otherwise indicate that switching to automatically controlling the robotic vehicle is not necessary. In another example, presence of conditions that indicate that the attention level of the operator is not impacted despite the conditions indicating a fall below an acceptable level may indicate whether to switch to automatic control (e.g., the presence of another individual to keep an eye on the robotic vehicle while the user is engaged in other activity, user of equipment such as a Bluetooth headset, experience level of the operator, etc.). In other examples, user or system settings may exist that indicate whether to switch to automatic control and before switching to automatic control, such settings may be checked. In other examples, certain conditions (e.g., malfunctions at the robotic vehicle, resources of the robotic vehicle, etc.) may indicate that despite the operator attention level, it may not be desirable to switch to automatically controlling the robotic vehicle.

If, in block 606, it is determined that the robotic vehicle should not be automatically controlled (determination block 606=No), one or more processor may continue to monitor the attention level of the operator in block 602 while still allowing the operator to control the robotic vehicle. If, on the other hand, it is determined that the robotic vehicle should be automatically controlled (determination block 606=Yes), then in block 608, one or more processors may cause the robotic vehicle to be automatically controlled (e.g., as described with respect to block 508).

In block 610, the attention level of the operator may be monitored (e.g., similar to block 602). If, in response to the monitoring in block 610, in block 612, it is determined that the attention level of the operator is above an acceptable level (determination block 612=Yes), then, in block 614, one or more processors may be configured to cause the control of the robotic vehicle to be returned to the operator. If, however, the attention level of the operator is not above the acceptable level (determination block 612=No), the robotic vehicle may continue to be controlled automatically.

In some examples, the duration of time from the switching of the control to automatic control may be tracked, and the automatic control of the robotic vehicle may be adjusted based on the duration. For example, for a first duration of time, automatically controlling the vehicle may include (but is not limited to) hovering the vehicle or continuing along the planned path, or in a straight line, but after a certain duration (greater than the first duration) automatic control of the robotic vehicle may cause the robotic vehicle to land (e.g., to conserve battery) or perform some other action from that performed in response to the first duration of time.

In various embodiments, during automatic control of the robotic vehicle, a change in types of activity or operator level of the attention may be detected. In various embodiments, automatic control of the robotic vehicle may be modified to address such changes (e.g., increase level of notification to operator to try and raise the attention level of the operator). In one example, modifying the automatically controlling of the robotic vehicle may include controlling the robotic vehicle to perform one or more actions different from a first set of actions being performed to automatically control the robotic vehicle in step 608. In some examples, while being automatically controlled, if the attention level of the operator changes (e.g., while still under an acceptable level), automatic control of the robotic vehicle may be adjusted based on the changed in attention level of the operator (e.g., increase level of notification to operator to try and raise the attention level of the operator, land the robotic vehicle, etc.). For example, if the attention level of the operator falls further below the threshold (e.g., operator engages in additional distracting activities, or other conditions lead to further distractions, etc.), one or more additional or alternative actions may be performed as part of automatically controlling the vehicle to address the change in attention level.

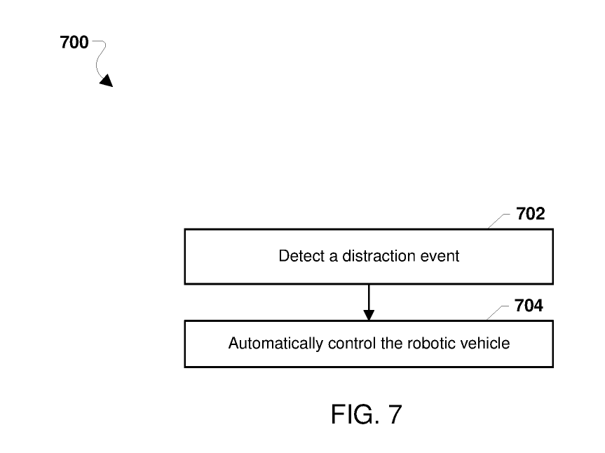

FIG. 7 illustrates an example method 700 for controlling operation of a robotic vehicle, according to various embodiments. With reference to FIGS. 1-7, the method 700 may be implemented in hardware components and/or software components of the robotic vehicle (e.g., 102, 200) and/or the wireless communication device (e.g., 290) the operation of which may be controlled by one or more processors (e.g., the processor 220, 310, 410, 414 and/or the like).

In block 702, one or more processors may detect a distraction event while a robotic vehicle is being controlled by an operator. In some examples, the one or more processors may detect a distraction event. In some examples, a distraction event is detected when one or more processors determine that the operator of the robotic vehicle is engaged in an activity other than controlling the robotic vehicle while controlling the robotic vehicle (i.e., a distraction activity). For example, while controlling the robotic vehicle, the operator may engage in a phone call, text message, email, chat or other conversation, or may engage with other applications (e.g., games). Such engagement in activities other than controlling the robotic vehicle may distract the operator such that the operator is unable to operate the robotic vehicle in a safe and efficient manner. In some examples, in response to an occurrence of a distraction event, one or more processors may receive an indication of a distraction event. In some examples, one or more processors may be configured to monitor the activities of the operator while the operator is controlling the robotic vehicle and may detect a distraction event. Activities of the operator may be monitored using one or more sensors or other equipment. For example, sensors or other equipment (e.g., cameras) of the controller of the robotic vehicle used by the operator may be used to monitor the attention level of the operator. Such sensors or other equipment may provide information or indications of activities the operator is engaged in while controlling the robotic vehicle.

In some embodiments, the operator may be associated with one or more user equipment (UE) and one or more UEs may provide information regarding the activities of the user, including activities the user engages in while the user is controlling the robotic vehicle. In some examples, the UE may also act as the controller of the robotic vehicle while in other examples, the UE may be separate from and/or optionally in communication with the controller of the robotic vehicle. In some example, the UE may include sensors and other equipment (e.g., cameras) that may provide information regarding the activities of the operator.

For example, the UE may provide information regarding operator engagement with one or more services or applications. In some examples, indications of the operator engaging in certain activities (e.g., answering a phone call, engaging in conversation, engaging with one or more other devices or applications, etc.) may be provided to or detected by one or more processors. Such indications may include information from the controller or UE, such as information regarding the applications at the UE the user is engaged with such as incoming/outgoing phone call, text message, email or chat conversation or engagement with other applications. In some examples, the information picked up by one or more sensors or equipment such as cameras or microphones (e.g., conversations on the phone or nearby person, orientation of the UE or controller, gestures of the operator associate with certain activities, etc.) may also provide indications of one or more activities of the user.

In some examples, the distraction event detection may be in response to the one or more processors determining that the robotic vehicle is being controlled by the operator. In another example, upon detecting the distraction event, the one or more processors may determine if the robotic vehicle is being controlled by an operator before proceeding to block 704. For example, the one or more processor may determine that the robotic vehicle is being controlled by the operator when the robotic vehicle is receiving one or more control commands from the operator. In other examples, the one or more processor may determine that the robotic vehicle is being controlled by the operator when the robotic vehicle is in a mode where it may be controlled by one or more commands from the operator. As another example, the robotic vehicle is being controlled by the operator when one or certain actions are performed by the operator (e.g., powering on the robotic vehicle, causing the robotic vehicle to take off, inputting a command, etc.).

In block 704, one or more processors may be configured to automatically control the robotic vehicle in response to detecting the distraction event. In some examples, automatically controlling the robotic vehicle may include overriding the operator control of the robotic vehicle, in whole or in part. In some example, automatically controlling the robotic vehicle may include the robotic vehicle entering an autonomous mode. In other examples, the robotic vehicle may communicate with a different entity or server to receive commands regarding actions to take once the operator control of the robotic vehicle is overridden.

In some examples, automatic control of the robotic vehicle may include, but is not limited to, engaging a hover mode, landing the robotic vehicle (e.g., straight down, designated location, return to home/operator, go to charging location), engaging an autopilot mode, causing the robotic vehicle to fly in a straight line, holding pattern, or other predetermined course/pattern, controlling (enable/disable) some features of the robotic vehicle (e.g., enable obstacle detection; increase rate of sampling for obstacle detection; disable camera; change sensitivity of controls; restrict speed and/or maneuverability; disable one or more commands; etc.), switching control to a third party, emitting some notification or alarm (e.g., “hazard lights”) to nearby people (operators/non-operators), drones, aircrafts, etc. indicating an inattentive operator, or perform some other predetermined action. In some embodiments, the automatic control of the robotic vehicle may be based on, but not limited to, one or more of default or system settings, user preferences, or contextual information such as robotic vehicle conditions (e.g., battery life, location, hazards or obstacles, population density, time, indoor versus outdoor, object density, etc.) and/or operator level of attention.

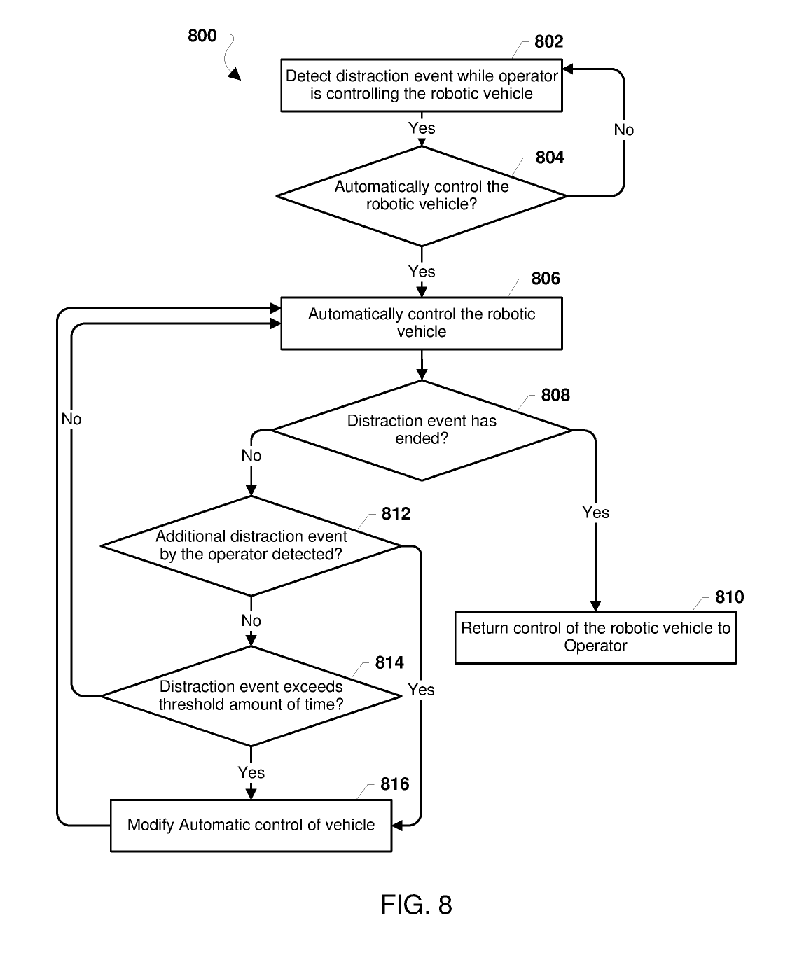

FIG. 8 illustrates an example method 800 for switching control of operation of a robotic vehicle based on detecting a distraction event, according to various embodiments. The method 800 includes operations that may be performed as part of determination blocks 702 and/or 704 (FIG. 7). With reference to FIGS. 1-8, the method 800 may be implemented in hardware components and/or software components of the robotic vehicle (e.g., 102, 200) and/or the wireless communication device (e.g., 290) the operation of which may be controlled by one or more processors (e.g., the processor 220, 310, 410, 414 and/or the like).

In some examples, in response to detecting a distraction event while the operator is controlling the robotic vehicle in block 802 (e.g., as described in block 702), in block 804, one or more processors may be configured to determine if control of the robotic vehicle should be switched from the operator control to automatically controlling the robotic vehicle. For example, a notification may be provided to the operator (e.g., at the controller or operator UE) indicating that a distraction event has been detected and/or that the robotic vehicle is about to be automatically controlled. In some examples, the operator may override the automatic control or may otherwise indicate that switching to automatically controlling the robotic vehicle is not necessary or desired at this time. In another example, presence of conditions that indicate that the operator is still operating the robotic vehicle in a safe or efficient manner despite the distraction event may indicate whether to switch to automatic control (e.g., the presence of another individual to keep an eye on the robotic vehicle while the user is engaged in other activity, user of equipment such as a Bluetooth headset, experience level of the operator, certain clearance, license, or permission granted to the operator and/or the robotic vehicle, a low density of objects nearby to which the robotic vehicle could impact, etc.).

In other examples, user or system settings may exist that indicate whether to switch to automatic control. In some examples, before switching to automatic control, such settings may be checked. In other examples, certain conditions (e.g., malfunctions at the robotic vehicle, resources of the robotic vehicle, weather conditions, etc.) may indicate that despite the distraction event, it may not be desirable to switch to automatically controlling the robotic vehicle.

If, in block 804, it is determined that the robotic vehicle should not be automatically controlled (determination block 804=No), while still allowing the operator to control the robotic vehicle, one or more processors may return to block 802, until another distraction event is detected, or a change occurs with respect to the same distraction event such that the one or more processors determine that the robotic vehicle should be controlled automatically. If, on the other hand, in block 804, it is determined that the robotic vehicle should be automatically controlled (determination block 804=Yes), in block 806, one or more processors may cause the robotic vehicle to be automatically controlled, for example as described above with respect tto block 704.

In block 808, one or more processors may determine if the distraction event has ended. In several embodiments, once the robotic vehicle is being automatically controlled, one or more processor may be configured to determine if the distraction event has ended. In some examples, one or more processors may receive an indication that the activity corresponding to the distraction event has ended. For example, the operator may hang up a call, stop a conversation or exit out of or put an application on the background. If, in block 808, it is determined that the distraction event has ended (determination block 808=Yes), then one or more processors may be configured to cause the control of the robotic vehicle to be returned to the operator in block 810.

If, however, in block 808, one or more processors determine that the distraction event has not ended (determination block 808=No), the robotic vehicle may continue to be controlled automatically (i.e., without operator intervention). In some examples, if one or more processors determine that the distraction event has not ended in block 808, the one or more processors may determine if one or more modifications to automatically controlling the robotic vehicle need to be made. In one example, modifying the automatically controlling of the robotic vehicle may include controlling the robotic vehicle to perform one or more actions different from a first set of actions being performed to automatically control the robotic vehicle in step 806. For example, in response to determining that the distraction event has not ended in block 808, one or more processors may determine if an additional distraction event (e.g., additional operator activities that distract the operator) is detected, in block 812.

In various embodiments, in response to determining that an additional distraction event has been detected in block 812 (determination block 812=Yes), automatic control of the robotic vehicle may be modified in block 816. For example, one or more processors may be configured to cause an increase in the level of notification to operator. In some examples, one or more additional or alternative actions may be performed as part of automatically controlling the vehicle to address the additional distraction event (e.g., landing the robotic vehicle instead of hovering, etc.). In one example, once the modification to the automatic control of the robotic vehicle, the process returns to block 806 to automatically control the robotic vehicle (e.g., modified according to block 816).

In some embodiments, if no additional detection event is detected in block 812 (determination block 812=No), in block 814, one or more processors may determine if the distraction event meets a threshold amount of time. In some embodiments, one or more processors may track the duration of time of the distraction event, and determine if the duration meets a threshold amount of time (e.g., is longer than some predetermined duration). In some examples, if in block 814, it is determined that the distraction event meets a threshold amount of time (determination block 814=Yes), the automatic control of the robotic vehicle may be modified in step 816 (e.g., based on the duration of the distraction event).

For example, for a first duration of time, automatically controlling the vehicle may include hovering the vehicle or continuing along the planned path, or in a straight line, but after a certain duration (greater than the first duration) automatic control of the robotic vehicle may cause the robotic vehicle to land (e.g., to conserve battery).

Otherwise, if the distraction event does not meet a threshold amount of time (determination block 814=No), one or more processors will continue automatic control of the robotic vehicle in block 806. In one example, once the modification to the automatic control of the robotic vehicle, the process returns to block 806 to automatically control the robotic vehicle (e.g., modified according to block 816).

Therefore, one or more processors may be configured to automatically control a robotic vehicle in response to detecting a distraction event and therefore may ensure that operator inattentiveness causes minimal impact to the drone, bystanders, and property and/or may conserve battery life until the operator can provide his/her undivided attention again, thus increasing the aggregate user experience for the operator.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 500, and 600 may be substituted for or combined with one or more operations of the methods 500, and 600, and vice versa.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the spirit or scope of the claims. Thus, the present disclosure is not intended to be limited to the embodiments shown herein but is to be accorded the widest scope consistent with the following claims and the principles and novel features disclosed herein.

What is claimed is:

1. A method of controlling a robotic vehicle, comprising:
detecting, by one or more processors, a distraction event while an operator is controlling the robotic vehicle; and
automatically controlling the robotic vehicle in response to detecting the distraction event.

2. The method of claim 1, wherein automatically controlling the robotic vehicle comprises controlling the robotic vehicle for the duration of the distraction event.

3. The method of claim 1,
wherein the robotic vehicle is controlled by the user using a user equipment; and
wherein detecting the distraction event while the operator is controlling the robotic vehicle comprises detecting the distraction event on the mobile communication device while the operator is controlling the robotic vehicle with the mobile communication device.

4. The method of claim 3, wherein the distraction event comprises receiving or placing a call on the mobile communication device.

5. The method of claim 3, wherein the distraction event comprises typing a message on the mobile communication device.

6. The method of claim 3, wherein the distraction event comprises switching from an application for controlling the robotic vehicle to a different application.

7. The method of claim 1,
wherein detecting the distraction event comprises detecting a distraction activity; and
wherein the distraction activity is an activity different from the controlling of the robotic vehicle.

8. The method of claim 1,
wherein detecting the distraction event comprises detecting a distraction activity; and
wherein the distraction activity comprises at least one of the operator engaging in a phone call, the operator engaging in a text, chat, or email message, and the operator engaging with a software application other than an application for controlling the robotic vehicle.

9. The method of claim 1, further comprising:
determining whether the distraction event has ended; and
returning control of the robotic vehicle to the operator in response to determining that the distraction event has ended.

10. The method of claim 1, further comprising:
determining a time duration of the distraction event;
determining whether the time duration of the distraction event exceeds a threshold; and
modifying the controlling of the robotic vehicle in response to the time duration exceeding the threshold.

11. The method of claim 10,
wherein automatically controlling the robotic vehicle comprises controlling the robotic vehicle to perform a first action; and
wherein modifying the controlling of the robotic vehicle in response to the time duration exceeding the threshold comprises controlling the robotic vehicle to perform a second action different from the first action.

12. The method of claim 1, further comprising:
detecting an additional distraction event during the controlling; and
modifying the controlling of the robotic vehicle based on the detecting of the additional distraction event.

13. The method of claim 12,
wherein automatically controlling the robotic vehicle comprises controlling the robotic vehicle to perform a first action; and
wherein modifying the controlling of the robotic vehicle based on the detecting of the additional distraction event comprises controlling the robotic vehicle to perform a second action different from the first action.

14. The method of claim 1, wherein automatically controlling the robotic vehicle comprises controlling the robotic vehicle by one or more processors of the robotic vehicle without receiving further commands from the operator.

15. The method of claim 1, wherein automatically controlling the robotic vehicle comprises requesting control commands from a source other than the operator.

16. A robotic vehicle, comprising:
a processor configured with processor-executable instructions to:
detect a distraction event while an operator is controlling the robotic vehicle; and
automatically control the robotic vehicle in response to detecting the distraction event.

17. The robotic vehicle of claim 16, wherein the processor is further configured with processor-executable instructions such that automatically controlling the robotic vehicle comprises controlling the robotic vehicle for the duration of the distraction event.

18. The robotic vehicle of claim 16, wherein the processor is further configured with processor-executable instructions such that:
the robotic vehicle is controlled by the user using a user equipment; and
detecting the distraction event while the operator is controlling the robotic vehicle comprises detecting the distraction event on the mobile communication device while the operator is controlling the robotic vehicle with the mobile communication device.

19. The robotic vehicle of claim 18, wherein the processor is further configured with processor-executable instructions such that the distraction event comprises receiving or placing a call on the mobile communication device.

20. The robotic vehicle of claim 18, wherein the processor is further configured with processor-executable instructions such that the distraction event comprises typing a message on the mobile communication device.

21. The robotic vehicle of claim 18, wherein the processor is further configured with processor-executable instructions such that the distraction event comprises switching from an application for controlling the robotic vehicle to a different application.

22. The robotic vehicle of claim 16, wherein the processor is further configured with processor-executable instructions such that:
detecting the distraction event comprises detecting a distraction activity; and
wherein the distraction activity is an activity different from the controlling of the robotic vehicle.

23. The robotic vehicle of claim 16, wherein the processor is further configured with processor-executable instructions such that:
detecting the distraction event comprises detecting a distraction activity; and
the distraction activity comprises at least one of the operator engaging in a phone call, the operator engaging in a text, chat, or email message, and the operator engaging with a software application other than an application for controlling the robotic vehicle.

24. The robotic vehicle of claim 16, wherein the processor is further configured with processor-executable instructions to:
determine whether the distraction event has ended; and
return control of the robotic vehicle to the operator in response to determining that the distraction event has ended.

25. The robotic vehicle of claim 16, wherein the processor is further configured with processor-executable instructions such that:
determine a time duration of the distraction event;
determine whether the time duration of the distraction event exceeds a threshold; and
modify the controlling of the robotic vehicle in response to the time duration exceeding the threshold.

26. The robotic vehicle of claim 25, wherein the processor is further configured with processor-executable instructions such that:
automatically controlling the robotic vehicle comprises controlling the robotic vehicle to perform a first action; and
modifying the controlling of the robotic vehicle in response to the time duration exceeding the threshold comprises controlling the robotic vehicle to perform a second action different from the first action.

27. The robotic vehicle of claim 16, wherein the processor is further configured with processor-executable instructions to:
detect an additional distraction event during the controlling; and
modify the controlling of the robotic vehicle based on the detecting of the additional distraction event.

28. The robotic vehicle of claim 27, wherein the processor is further configured with processor-executable instructions such that:
automatically controlling the robotic vehicle comprises controlling the robotic vehicle to perform a first action; and
modifying the controlling of the robotic vehicle based on the detecting of the additional distraction event comprises controlling the robotic vehicle to perform a second action different from the first action.

29. One or more processors configured with processor-executable instructions to:
detect a distraction event while an operator is controlling the robotic vehicle; and
automatically control the robotic vehicle in response to detecting the distraction event.

30. A robotic vehicle, comprising:
means for detecting a distraction event while an operator is controlling the robotic vehicle; and
means for automatically controlling the robotic vehicle in response to detecting the distraction event.
